(19) United States
(12) Patent Application Publication
(10) Pub. No.: US 2025/0309345 A1
(43) Pub. Date: Oct. 2, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Dahyun KIM, Yongin-si (KR); SANGHOON KIM, Yongin-si (KR); Myunghoon KIM, Yongin-si (KR); Aeran KIM, Yongin-si (KR); Seungryong OH, Yongin-si (KR); Jeongmin SHIN, Yongin-si (KR)

(21) Appl. No.: 18/915,080

(22) Filed: Oct. 14, 2024

(30) Foreign Application Priority Data
Mar. 29, 2024 (KR) 10-2024-0043509

(51) Int. Cl. H01M 10/0567; H01M 10/0525; H01M 10/42

(52) U.S. Cl. CPC H01M 10/0567; H01M 10/0525; H01M 10/4235; H01M 2300/004

(57) ABSTRACT

Disclosed are electrolytes and rechargeable lithium batteries including the same. The electrolyte for a rechargeable lithium battery includes a non-aqueous organic solvent, a lithium salt, and an additive. The additive includes a first compound represented by Chemical Formula 1 and a second compound represented by Chemical Formula 2.

### CROSS-REFERENCE TO RELATED APPLICATION

The present application claims priority to and the benefit of Korean Patent Application No. 10-2024-0043509 filed on Mar. 29, 2024, in the Korean Intellectual Property Office, the entire content of which is hereby incorporated by reference.

### BACKGROUND

### 1. Field

Embodiments of the present disclosure relate to an electrolyte for a rechargeable lithium battery and a rechargeable lithium battery including the same.

### 2. Description of Related Art

Recently, with the rapid spread of battery using electronic devices, such as mobile phones, laptop computers, and electric vehicles, there is a rapidly increasing demand for rechargeable batteries having high energy density and high capacity. Therefore, intensive research has been conducted to improve performance of rechargeable lithium batteries.

A rechargeable lithium battery includes a positive electrode, a negative electrode, and an electrolyte, which positive and negative electrodes include an active material in which intercalation and deintercalation of lithium are possible, and generates electrical energy caused by oxidation and reduction reactions if lithium ions are intercalated and deintercalated.

### SUMMARY

An embodiment of the present disclosure provides a rechargeable lithium battery having improved lifetime and high-temperature storage characteristics.

According to an embodiment of the present disclosure, an electrolyte for a rechargeable lithium battery includes: a non-aqueous organic solvent; a lithium salt; and an additive. The additive may include a first compound represented by Chemical Formula 1 and a second compound represented by Chemical Formula 2.

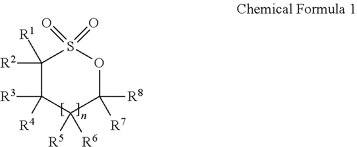

In Chemical Formula 1,
R¹ to R⁸ may each independently be hydrogen or a substituted or unsubstituted C10 to C10 alkyl group, and
n may be an integer of 1 to 8.

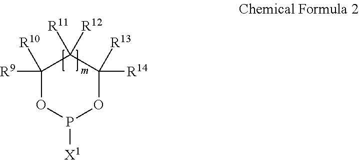

In Chemical Formula 2,
X¹ may be a fluoro group, a chloro group, a bromo group, or an iodo group (e.g., —F, —Cl, —Br, or —I),
R⁹ to R¹⁴ may each independently be hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
m may be 0 or 1.

According to an embodiment of the present disclosure, a rechargeable lithium battery may include: a positive electrode that includes a positive electrode active material; a negative electrode that includes a negative electrode active material; and the electrolyte for the rechargeable lithium battery.

### BRIEF DESCRIPTION OF DRAWINGS

The accompanying drawings, together with the specification, illustrate embodiments of the subject matter of the present disclosure, and, together with the description, serve to explain principles of embodiments of the subject matter of the present disclosure.

FIG. 1 is a simplified conceptual diagram showing a rechargeable lithium battery according to an embodiment of the present disclosure.

FIGS. 2-5 are simplified diagrams showing rechargeable lithium batteries according to embodiments of the present disclosure.

FIG. 6 is a graph showing capacity retention rates of rechargeable lithium batteries according to Embodiments 1 to 3 and Comparative Examples 1 to 3.

### DETAILED DESCRIPTION OF EMBODIMENTS

In order to sufficiently understand the configuration and effect of the subject matter of the present disclosure, some embodiments of the present disclosure will be described with reference to the accompanying drawings. It should be noted, however, that the subject matter of the present disclosure is not limited to the following example embodiments, and may be implemented in various suitable forms. Rather, the example embodiments are provided only to disclose the subject matter of the present disclosure and let those of ordinary skill in the art fully know the scope of the present disclosure.

In this description, it will be understood that, if an element is referred to as being on another element, the element can be directly on the other element or intervening elements may be present between therebetween. In the drawings, thicknesses of some components may be exaggerated to effectively explain the technical contents of the present disclosure. Like reference numerals refer to like elements throughout the specification.

Unless otherwise specially noted in this description, the expression of a singular form may include the expression of a plural form. In embodiments, unless otherwise specially noted, the phrase “A or B” may indicate “A but not B”, “B but not A”, and “A and B”. The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, and/or a reaction product.

In this description, unless otherwise separately defined, the term “substituted” may indicate that at least one hydrogen of a substituent or a compound is substituted by deuterium, a halogen group, a hydroxyl group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, or a combination thereof.

In more detail, the term “substituted” may indicate that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may indicate that at least one hydrogen of a substituent or a compound is substituted by deuterium, a halogen group, a C1 to C20 alkyl group, a C6 to C30 aryl group, a C1 to C10 fluoroalkyl group, or a cyano group. In embodiments, the term “substituted” may indicate that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may indicate that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluomethyl group, or a naphthyl group.

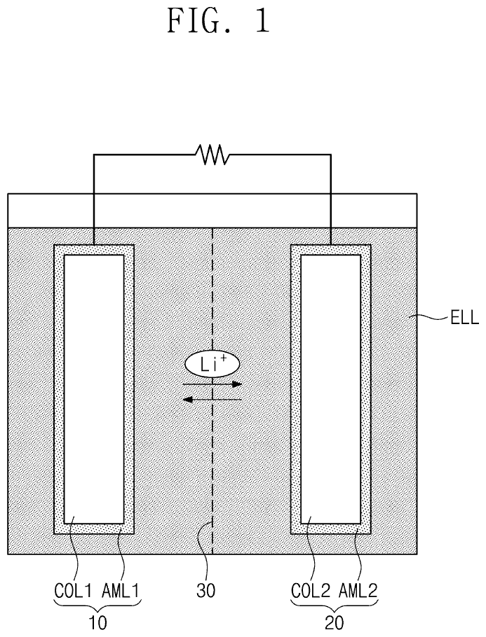

FIG. 1 is a simplified conceptual diagram showing a rechargeable lithium battery according to an embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated with the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 or the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and further include a binder and/or a conductive material (e.g., an electrically conductive material).

For example, the positive electrode 10 may further include an additive that can serve as a sacrificial positive electrode.

An amount of the positive electrode active material may be about 90 wt % to about 99.5 wt % relative to 100 wt % of the positive electrode active material layer AML1. An amount of each of the binder and the conductive material may be about 0.5 wt % to about 5 wt % relative to 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and/or nylon, but the present disclosure is not limited thereto.

The conductive material may be used to provide an electrode with conductivity (e.g., electrical conductivity), and any suitable conductive material that does not cause a chemical change of a battery (e.g., does not cause an undesirable chemical change in the rechargeable lithium battery) may be used as the conductive material to constitute the battery. The conductive material may include, for example, a carbon-based material such as natural graphite, artificial graphite, carbon black, acetylene black, Ketjenblack, carbon fiber, carbon nano-fiber, and/or carbon nano-tube; a metal powder and/or metal fiber containing one or more of copper, nickel, aluminum, and/or silver; a conductive polymer (e.g., an electrically conductive polymer) such as a polyphenylene derivative; or a mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is selected from cobalt, manganese, nickel, and a combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound represented by one selected from chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}CO_{b}X_{c}O₂₋ₐDₐ (where 0.90≤a≤1.8, 0≤b≤0.5, 0≤c≤0.5, and 0<<<2); LiₐNi_{1-b-c}Mn_{b}X_{c}O₂₋ₐDₐ (where 0.90≤a≤1.8, 0≤b≤0.5, 0≤c≤0.5, and 0<<<2); LiₐNi_{b}CO_{C}L¹_{d}GeO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)} Fe₂(PO₄)₃ (where 0≤f≤2); and LiₐFePO₄ (where 0.90≤a≤1.8).

In the chemical formulae above, A is Ni, Co, Mn, or a combination thereof, X is Al, Ni, Co, Mn, Cr, Fe, Mg, Sr, V, a rare-earth element, or a combination thereof, D is O, F, S, P, or a combination thereof, G is Al, Cr, Mn, Fe, Mg, La, Ce, Sr, V, or a combination thereof, and L¹ is Mn, Al, or a combination thereof.

For example, the positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity and thus may be applied to a high-capacity and high-density (e.g., high energy density) rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material and may further include a binder and/or a conductive material (e.g., an electrically conductive material).

For example, the negative electrode active material layer AML2 may include a negative electrode active material of about 90 wt % to about 99 wt %, a binder of about 0.5 wt % to about 5 wt %, and a conductive material (e.g., an electrically conductive material) of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylic rubber, butyl rubber, fluoro elastomer, polyethylene oxide, polyvinyl pyrrolidone, polyepichlorohydrin, polyphosphazene, poly(meth) acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

If an aqueous binder is used as the negative electrode binder, a cellulose-based compound capable of providing or increasing viscosity may further be included. The cellulose-based compound may include one or more selected from carboxymethyl cellulose, hydroxypropylmethyl cellulose, methyl cellulose, and alkali metal salts thereof. The alkali metal may include Na, K, and/or Li.

The dry binder may include a fibrillizable polymer material, for example, polytetrafluoroethylene, polyvinylidene fluoride, polyvinylidene fluoride-hexafluoropropylene copolymer, polyethylene oxide, or a combination thereof.

The conductive material may be used to provide an electrode with conductivity (e.g., electrical conductivity), and any suitable conductive material that does not cause a chemical change of a battery (e.g., does not cause an undesirable chemical change in the rechargeable lithium battery) may be used as the conductive material to constitute the battery. For example, the conductive material may include a carbon-based material such as natural graphite, artificial graphite, carbon black, acetylene black, Ketjenblack, carbon fiber, carbon nano-fiber, and/or carbon nano-tube; a metal powder and/or metal fiber including one or more of copper, nickel, aluminum, and/or silver; a conductive polymer (e.g., an electrically conductive polymer) such as a polyphenylene derivative; or a mixture thereof.

The current collector COL2 may include a copper foil, a nickel foil, a stainless-steel foil, a titanium foil, a nickel foam, a copper foam, a polymer substrate coated with a conductive metal (e.g., an electrically conductive metal), or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, and/or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, and/or fiber-shaped natural and/or artificial graphite, and the amorphous carbon may include soft carbon, hard carbon, mesophase pitch carbon, and/or calcined coke.

The lithium metal alloy may include an alloy of lithium and metal that is selected from Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material and/or a Sn-based negative electrode active material. The Si-based negative electrode active material may include silicon, silicon-carbon composite, SiOₓ (where 0<x<2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may have a structure in which the amorphous carbon is coated on a surface of the silicon particle. For example, the silicon-carbon composite may include a secondary particle (core) in which primary silicon particles are assembled (e.g., agglomerated), and an amorphous carbon coating layer (shell) on a surface of the secondary particle. The amorphous carbon may also be between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

The Si-based negative electrode active material and/or the Sn-based negative electrode active material may be used in combination with a carbon-based negative electrode active material.

### Separator 30

Based on a type (or kind) of the rechargeable lithium battery, the separator 30 may be present between positive electrode 10 and the negative electrode 20. The separator 30 may include one or more selected from polyethylene, polypropylene, and polyvinylidene fluoride, and may have a multi-layered separator thereof such as a polyethylene/polypropylene bi-layered separator, a polyethylene/polypropylene/polyethylene tri-layered separator, and/or a polypropylene/polyethylene/polypropylene tri-layered separator.

The separator 30 may include a porous substrate and a coating layer on one or opposite surfaces (e.g., opposing surfaces) of the porous substrate, which coating layer includes an organic material, an inorganic material, or a combination thereof.

The porous substrate may be a polymer layer including one selected from polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be a copolymer or mixture including two or more of the materials mentioned above.

The organic material may include a polyvinylidenefluoride-based copolymer and/or a (meth)acrylic copolymer.

The inorganic material may include an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be present mixed together in one coating layer or may be present as a stack of a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may serve as a medium that transmits ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The aprotic solvent may include nitriles such as R—CN (where R is a hydrocarbon group having a C2 to C20 linear, branched, or cyclic structure and may include a double bond, an aromatic ring, and/or an ether group); amides such as dimethylformamide; dioxolanes such as 1,3-dioxolane and/or 1,4-dioxolane; and/or sulfolanes.

The non-aqueous organic solvent may be used alone or in a mixture of two or more substances.

In embodiments, if a carbonate-based solvent is used, a cyclic carbonate and a chain carbonate may be mixed together and used, and the cyclic carbonate and the chain carbonate may be mixed together in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. The lithium salt may include, for example, at least one selected from LiPF₆, LiBF₄, LiSbF₆, LiAsF₆, LiCIO₄, LIAIO₂, LiAICI₄, LIPO₂F₂, LICI, Lil, LIN (SO₃C₂F₅)₂, Li(FSO₂)₂N (lithium bis(fluorosulfonyl)imide, LiFSI), LiC₄F₉SO₃, LIN (CₓF₂ₓ₊₁SO₂) (C_{y}F_{2y+1}SO₂) (where x and y are integers of 1 to 20), lithium trifluoromethane sulfonate, lithium tetrafluoroethanesulfonate, lithium difluorobis(oxalato)phosphate (LiDFBOP), and lithium bis(oxalato) borate (LiBOB).

### Rechargeable Lithium Battery

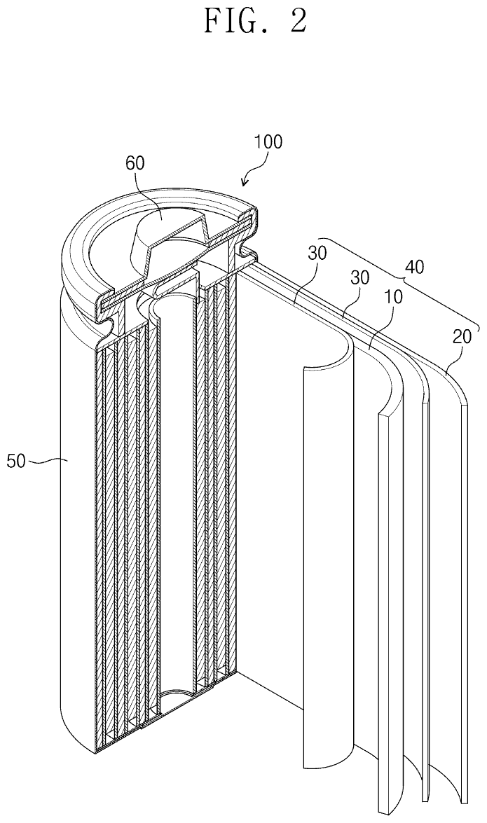

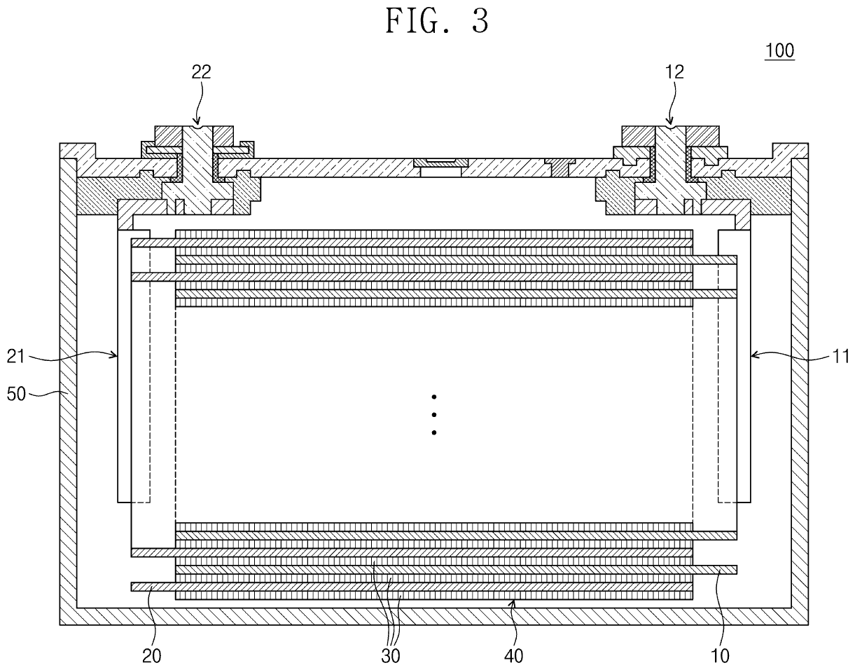

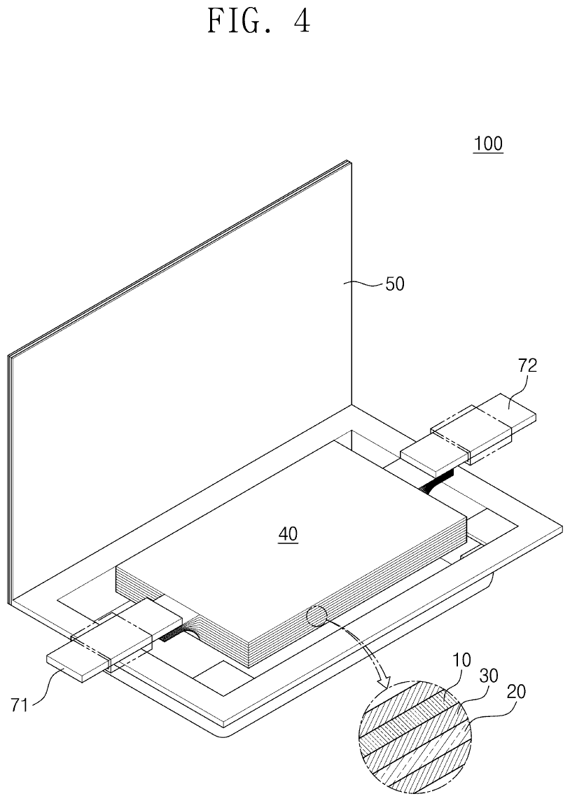

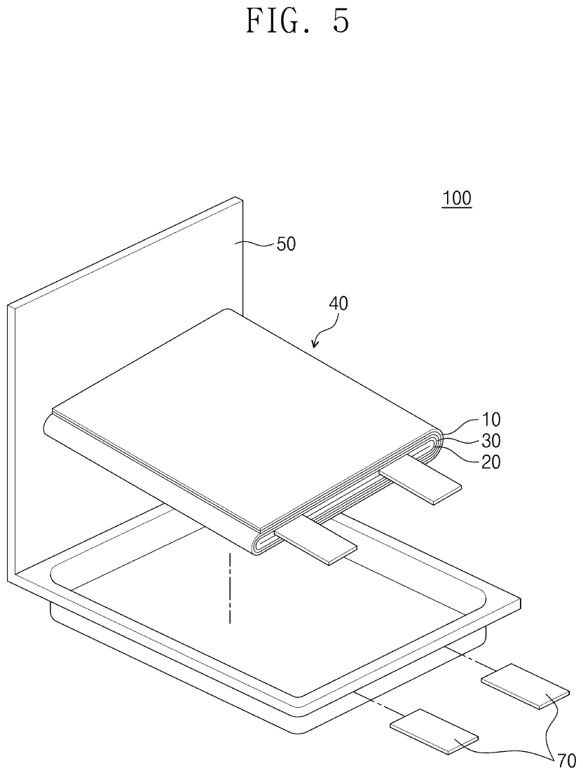

Based on a shape of a rechargeable lithium battery, the rechargeable lithium battery may be classified into cylindrical, prismatic, pouch, and/or coin types (or kinds). FIGS. 2-5 are simplified diagrams showing rechargeable lithium batteries according to embodiments, in which FIG. 2 shows a cylindrical battery, FIG. 3 shows a prismatic battery, and FIGS. 4-5 show pouch-type batteries. Referring to FIGS. 2-4, a rechargeable lithium battery 100 may include an electrode assembly 40 in which a separator 30 is between a positive electrode 10 and a negative electrode 20, and may also include a casing 50 in which the electrode assembly 40 is accommodated. The positive electrode 10, the negative electrode 20, and the separator 30 may be impregnated with an electrolyte. The rechargeable lithium battery 100 may include a sealing member 60 that seals the casing 50 as illustrated in FIG. 2. In embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4-5, the rechargeable lithium battery 100 may include an electrode tab 70 (FIG. 5), or a positive electrode tab 71 and a negative electrode tab 72 (FIG. 4), which electrode tab 70 serves as an electrical path for externally inducing a current generated in the electrode assembly 40.

A rechargeable lithium battery according to an embodiment of the present disclosure may be applied to automotive vehicles, mobile phones, and/or any other suitable electrical devices, but the present disclosure is not limited thereto.

The following will describe in more detail an electrolyte for a rechargeable lithium battery according to some embodiments of the present disclosure.

An electrolyte for a rechargeable lithium battery according to an embodiment may include a non-aqueous organic solvent, a lithium salt, and an additive, which additive may include a first compound represented by Chemical Formula 1 below and a second compound represented by Chemical Formula 2 below.

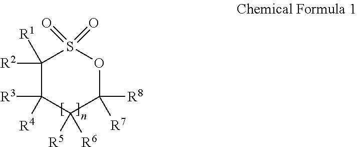

In Chemical Formula 1,
R¹ to R⁸ may each independently be hydrogen or a substituted or unsubstituted C1 to C10 alkyl group, and n may be an integer of 1 to 8.

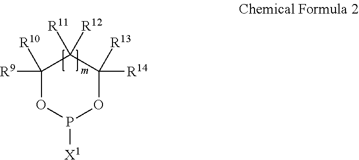

In Chemical Formula 2,
X¹ may be a fluoro group, a chloro group, a bromo group, or an iodo group (e.g., —F, —Cl, —Br, or —I).
R⁹ to R¹⁴ may each independently be hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group. The subscript m may be 0 or 1.

According to some embodiments of the present disclosure, the non-aqueous organic solvent may be a mixed solvent of ethylene carbonate (EC), ethylmethyl carbonate (EMC), and dimethyl carbonate (DMC).

For example, the ethylene carbonate (EC) solvent may be included in an amount of about 5 vol % to about 40 vol % or about 10 vol % to about 30 vol % relative to a total volume of the non-aqueous organic solvent. The ethylmethyl carbonate (EMC) solvent may be included in an amount of about 5 vol % to about 20 vol % or about 5 vol % to about 15 vol % relative to the total volume of the non-aqueous organic solvent. The dimethyl carbonate (DMC) solvent may be included in an amount of about 50 vol % to about 90 vol % or about 60 vol % to about 80 vol % relative to the total volume of the non-aqueous organic solvent.

In an electrolyte according to some embodiment of the present disclosure, the lithium salt may include LiPF₆.

The lithium salt may have a concentration of about 0.1 M to about 2.0 M. For example, the lithium salt may have a concentration of equal to or greater than about 0.5 M or about 1.0 M. The lithium salt may have a concentration of equal to or less than about 2.0 M, equal to or less than about 1.7 M, or equal to or less than about 1.5 M. In the present disclosure, if the lithium salt has a concentration of about 0.1 M to about 2.0 M, the electrolyte may suitably or appropriately maintain its conductivity (e.g., electrical conductivity) and viscosity.

### First Compound

The first compound according to an embodiment of the present disclosure may be represented by Chemical Formula 1 below.

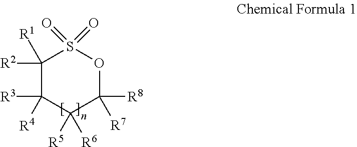

In Chemical Formula 1,
R¹ to R⁸ may each independently be hydrogen or a substituted or unsubstituted C1 to C10 alkyl group, and n may be an integer of 1 to 8.

For example, all of R¹ to R⁸ may be hydrogen, and the first compound represented by Chemical Formula 1 may be represented by Chemical Formula 1A below. The first compound may be 1,4-butane sultone.

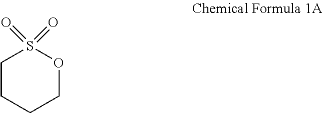

The first compound may protect films on surfaces of the positive and negative electrodes and may reduce a side reaction in the electrolyte. For example, although the present disclosure is not limited by any particular mechanism or theory, it is believed that a lone pair of electrons of a sulfonate group may act on a Lewis acid (e.g., PF₅) possibly present in the electrolyte to stabilize the Lewis acid. In embodiments, the unshared electron pair may also stabilize transition metal present on or released from the surface of the positive electrode. This may prevent or reduce a deterioration of the positive electrode to increase a lifetime of the battery.

The first compound may be present in an amount of about 0.5 parts by weight to about 5.0 parts by weight relative to 100 parts by weight of the electrolyte for the rechargeable lithium battery. For example, the first compound may be present in an amount of about 1.0 part by weight to about 3.0 parts by weight relative to 100 parts by weight of the electrolyte for the rechargeable lithium battery. The amount of the first compound may refer to a weight of the first compound included in the total weight of the electrolyte. If the amount of the first compound satisfies the ranges above, it may be possible not only to protect an electrode film but also to maximize or increase an interaction with a second compound which will be further discussed below.

### Second Compound

The second compound according to an embodiment of the present disclosure may be represented by Chemical Formula 2 below.

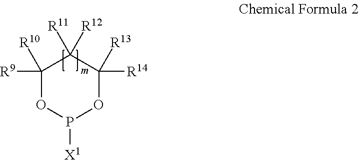

In Chemical Formula 2,
X¹ may be a fluoro group, a chloro group, a bromo group, or an iodo group (e.g., —F, —Cl, —Br, or —I).
R⁹ to R¹⁴ may each independently be hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and m may be 0 or 1.

The second compound may form, on the surface of the negative electrode, a solid electrolyte interface (SEI) layer with high-temperature stability and excellent ion conductivity. In embodiments, the second compound may reduce a gas generation caused by a decomposition reaction that occurs in the electrolyte during high-temperature storage. For example, although the present disclosure is not limited by any particular mechanism or theory, it is believed that a —PO₂F functional group of the second compound may stabilize a pyrolyzed product of the lithium salt such as LiPF₆ and/or ions dissociated from the lithium salt to reduce the generation of gas such as HF. The formation of the excellent SEI layer and the reduction in gas generation may contribute to a decrease in battery internal resistance (e.g., battery internal electrical resistance) and an improvement in lifetime characteristics at high temperatures of the rechargeable lithium battery.

The decrease in battery internal resistance and the improvement in lifetime characteristics at high temperatures caused by the second compound may become more pronounced in the case of the use of a high-nickel-based positive electrode active material and a negative electrode active material that includes graphite and silicon nano-particles. For example, silicon particles may be utilized to increase battery capacity, but there may be a problem of an increase in battery internal resistance due to a side reaction between the silicon particles and the electrolyte. If the second compound is introduced as the additive, the side reaction between the silicon particles and the electrolyte may be suppressed or reduced not only to minimize or reduce an increase in battery internal resistance, but also to maximize or improve an increase in battery capacity.

The second compound may include a cyclic phospholane derivative. Compared to a linear phosphite derivative, the cyclic phospholane derivative may cause a significant improvement in lifetime characteristics of the rechargeable lithium battery. Although the present disclosure is not limited by any particular mechanism or theory, it is believed that the foregoing may be caused by the fact that the linear phosphite derivative induces a side reaction of LiPF₆ due to the dissociated-PO₂F functional group and causes gas generation due to a decomposition reaction of the electrolyte during high-temperature storage.

In an embodiment, the second compound represented by Chemical Formula 2 may be represented by Chemical Formula 2A or 2B below.

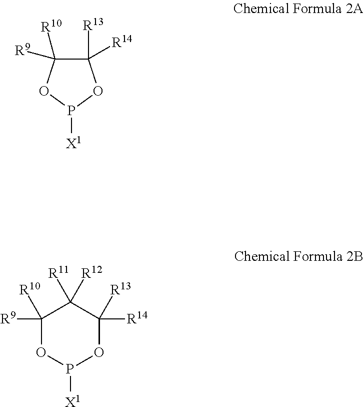

In Chemical Formula 2A and Chemical Formula 2B,
X¹ may be a fluoro group, a chloro group, a bromo group, or an iodo group (e.g., —F, —Cl, —Br, or —I).
R⁹ to R¹⁴ may each independently be hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In an embodiment, R⁹ and R¹⁰ of Chemical Formula 2A may each be hydrogen.

At least one selected from R¹³ and R¹⁴ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In an embodiment, the second compound may be at least one selected from compounds represented by Chemical Formulae 2C and 2D below. For example, the second compound may be at least one selected from 2-fluoro-1,3,2-dioxaphospholane and 2-fluoro-4-methyl-1,3,2-dioxaphospholane.

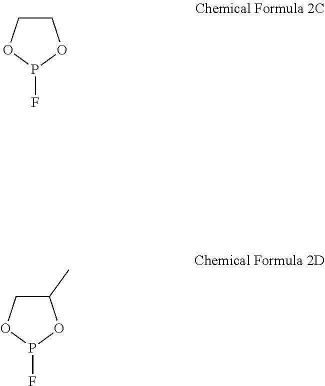

The second compound may be in present an amount of about 0.2 parts by weight to about 2.0 parts by weight relative to 100 parts by weight of the electrolyte for the rechargeable lithium battery. For example, the second compound may be present in an amount of about 0.5 parts by weight to about 1.5 parts by weight relative to 100 parts by weight of the electrolyte for the rechargeable lithium battery. The amount of the second compound may refer to a weight of the second compound included in the total weight of the electrolyte. If the amount of the second compound satisfies the ranges above, it may be possible to maximize or increase the effect of reduction in gas generation and the effect of formation of the excellent SEI layer at high temperatures.

The additive that includes all of the first compound and the second compound may have an amount of about 0.7 parts by weight to about 7 parts by weight, about 1.2 parts by weight to about 5 parts by weight, or about 2 parts by weight to about 5 parts by weight relative to 100 parts by weight of the electrolyte. If the amount of the additive satisfies the ranges above, it may be possible to maximize or increase an improvement in battery resistance (e.g., electrical resistance), to optimize or increase the prevention or reduction of transition metal dissolution, and to inhibit or reduce a side reaction due to an excessive content of the additive. This improvement in battery characteristics may become more pronounced, for example, at high temperatures.

A weight ratio of the first compound to the second compound in the additive may range from about 1 to about 5, for example, from about 1 to about 3. If the first compound and the second compound are in the weight ratio ranges above, it may be effective to form a strong film and to protect the film.

In an embodiment, the additive may further include at least one selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithium tetrafluoroborate (LiBF₄), lithium difluorophosphate (LiPO₂F₂), and 2-fluoro biphenyl (2-FBP).

The following describes Embodiments and Comparative Examples of the present disclosure. The following Embodiments, however, are merely examples, and the present disclosure is not limited to the Embodiments discussed below.

### EMBODIMENTS AND COMPARATIVE EXAMPLES

An electrolyte and a rechargeable lithium battery were fabricated by the following method.

### Embodiment 1

### (1) Preparation of Electrolyte

1.5 M LiPF₆ was dissolved in a non-aqueous organic solvent containing ethylene carbonate (EC), ethylmethyl carbonate (EMC), and dimethyl carbonate (DMC) mixed together in a volume ratio of about 20:10:70, and 0.5 wt % of a first compound and 1 wt % of a second compound were added to prepare an electrolyte.

A material represented by Chemical Formula 1A below was used as the first compound, and a material represented by Chemical Formula 2D below was used as the second compound.

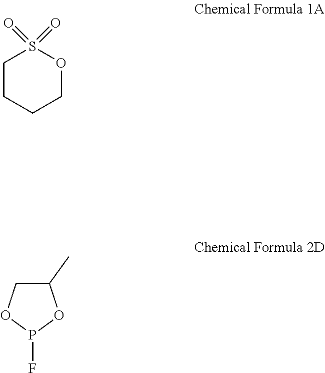

### (2) Fabrication of Rechargeable Lithium Battery

LiNi_{0.91}Co_{0.07}Al_{0.02}O₂ as a positive electrode active material, polyvinylidene fluoride as a binder, and carbon black as a conductive material were mixed together in a weight ratio of 97:2:1, and the mixture was dispersed in N-methyl pyrrolidone to prepare a positive electrode active material slurry.

The positive electrode active material slurry was coated on an Al current collector of 14 μm in thickness, dried at 110° C., and then pressed to manufacture a positive electrode.

Artificial graphite and silicon nano-particles mixed together in a weight ratio of 93:7 as a negative electrode active material, styrene butadiene rubber (SBR) as a binder, and carboxymethyl cellulose (CMC) as a thickener were mixed together in a weight ratio of 97:1:2, and the resultant mixture was distributed in distilled water to prepare a negative electrode active material slurry.

The negative electrode active material slurry was coated on a Cu current collector of 10 μm in thickness, dried at 100° C., and then pressed to manufacture a negative electrode.

The positive electrode, the negative electrode, and a polyethylene separator of 25 μm in thickness were assembled to manufacture an electrode assembly, and the electrolyte was introduced to fabricate a rechargeable lithium battery.

### Embodiment 2

An electrolyte and a rechargeable lithium battery were fabricated according to substantially the same method as in Embodiment 1, except that 1 wt % of the first compound and 1 wt % of the second compound were added as the additive when the electrolyte was prepared.

### Embodiment 3

An electrolyte and a rechargeable lithium battery were fabricated according to substantially the same method as in Embodiment 1, except that 2 wt % of the first compound and 1 wt % of the second compound were added as the additive when the electrolyte was prepared.

### Embodiment 4

An electrolyte and a rechargeable lithium battery were fabricated according to substantially the same method as in Embodiment 1, except that 3 wt % of the first compound and 1 wt % of the second compound were added as the additive when the electrolyte was prepared.

### Embodiment 5

An electrolyte and a rechargeable lithium battery were fabricated according to substantially the same method as in Embodiment 1, except that 5 wt % of the first compound and 1 wt % of the second compound were added as the additive when the electrolyte was prepared.

### Comparative Example 1

An electrolyte and a rechargeable lithium battery were fabricated according to substantially the same method as in Embodiment 1, except that no additive is added when the electrolyte was prepared.

### Comparative Example 2

An electrolyte and a rechargeable lithium battery were fabricated according to substantially the same method as in Embodiment 1, except that 1 wt % of the first compound was only added as the additive when the electrolyte was prepared.

### Comparative Example 3

An electrolyte and a rechargeable lithium battery were fabricated according to substantially the same method as in Embodiment 1, except that 1 wt % of the second compound was only added as the additive when the electrolyte was prepared.

### Comparative Example 4

An electrolyte and a rechargeable lithium battery were fabricated according to substantially the same method as in Embodiment 1, except that 1 wt % of the compound represented by Chemical Formula 2D above and 1 wt % of a compound represented by Chemical Formula 3 below were added as the additive when the electrolyte was prepared.

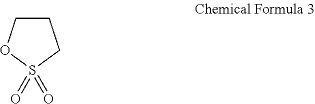

### Comparative Example 5

An electrolyte and a rechargeable lithium battery were fabricated according to substantially the same method as in Embodiment 1, except that 1 wt % of the compound represented by Chemical Formula 2D above and 2 wt % of a compound represented by Chemical Formula 3 below were added as the additive when the electrolyte was prepared.

### Comparative Example 6

An electrolyte and a rechargeable lithium battery were fabricated according to substantially the same method as in Embodiment 1, except that 1 wt % of the compound represented by Chemical Formula 2D above and 3 wt % of a compound represented by Chemical Formula 3 below were added as the additive when the electrolyte was prepared.

### Evaluation Example 1: Resistance Increase Rate at High-Temperature Storage

Rechargeable lithium batteries fabricated in the Embodiments and Comparative Examples were charged at room temperature (25° C.) to SOC 100% under the condition of constant current-constant voltage (CC/CV), 0.33 C, 4.25 V, and 0.025 C cut-off, and then an initial battery resistance (DC-IR) and a battery resistance (DC-IR) after storage at 60° C. for 90 days were measured. A resistance increase rate was measured and the result is listed in Table 1 below. A resistance (DC-IR), which is calculated from a difference in current and voltage when different currents are applied, was obtained with Ohm's law ΔR=ΔV/ΔI after being discharged at 1 C for 30 seconds in an initial full charge state. The resistance increase rate was calculated according to Equation 1 below.

$$Resistance increase rate ( \% ) = [ battery resistance ( DC ‐ IR ) after 90 days / initial battery resistance ( DC ‐ IR ) ] \times 100 \qquad Equation 1$$

TABLE 1

| | | | | | | DC-IR | |
|---|---|---|---|---|---|---|---|
| | | | | | | after high- | DC-IR |
| | First compound | | Second compound | | Initial | temperature | increase |
| | | Amount | | Amount | DC-IR | storage | rate |
| | Kind | (wt %) | Kind | (wt %) | (mΩ) | (mΩ) | (%) |
| Embodiment | Chemical | 0.5 | Chemical | 1 | 35.22 | 38.67 | 109.8 |
| | Formula | | Formula | | | | |
| 1 | 1A | | 2D | | | | |
| Embodiment | Chemical | 1 | Chemical | 1 | 34.70 | 37.30 | 107.5 |
| 2 | Formula | | Formula | | | | |
| | 1A | | 2D | | | | |
| Embodiment | Chemical | 2 | Chemical | 1 | 34.48 | 36.69 | 106.4 |
| | Formula | | Formula | | | | |
| 3 | 1A | | 2D | | | | |
| Embodiment | Chemical | 3 | Chemical | 1 | 34.96 | 37.79 | 108.1 |
| 4 | Formula | | Formula | | | | |
| | 1A | | 2D | | | | |
| Embodiment | Chemical | 5 | Chemical | 1 | 35.17 | 38.51 | 109.5 |
| 5 | Formula | | Formula | | | | |
| | 1A | | 2D | | | | |
| Comparative | — | — | — | — | 43.21 | 54.01 | 125.0 |
| Example 1 | | | | | | | |
| Comparative | Chemical | 1 | — | — | 40.66 | 45.70 | 112.4 |
| Example 2 | Formula | | | | | | |
| | 1A | | | | | | |
| Comparative | — | — | Chemical | 1 | 41.14 | 45.91 | 111.6 |
| Example 3 | | | Formula | | | | |
| | | | 2D | | | | |
| Comparative | Chemical | 1 | Chemical | 1 | 41.05 | 46.43 | 113.1 |
| Example 4 | Formula 3 | | Formula | | | | |
| | | | 2D | | | | |
| Comparative | Chemical | 2 | Chemical | 1 | 40.92 | 46.12 | 112.7 |
| Example 5 | Formula 3 | | Formula | | | | |
| | | | 2D | | | | |
| Comparative | Chemical | 3 | Chemical | 1 | 41.09 | 46.39 | 112.9 |
| Example 6 | Formula 3 | | Formula | | | | |
| | | | 2D | | | | |

Referring to Table 1, it may be ascertained that not only the initial resistance, but also the resistance increase rate after high-temperature storage is lower in the rechargeable lithium batteries according to Embodiments 1 to 5 in which the compound represented by Chemical Formula 1A and the compound represented by Chemical Formula 2D were added as the additive than in the rechargeable lithium batteries according to Comparative Examples 1 to 6.

### Evaluation Example 2: High-Temperature Lifetime Capacity Retention Rate

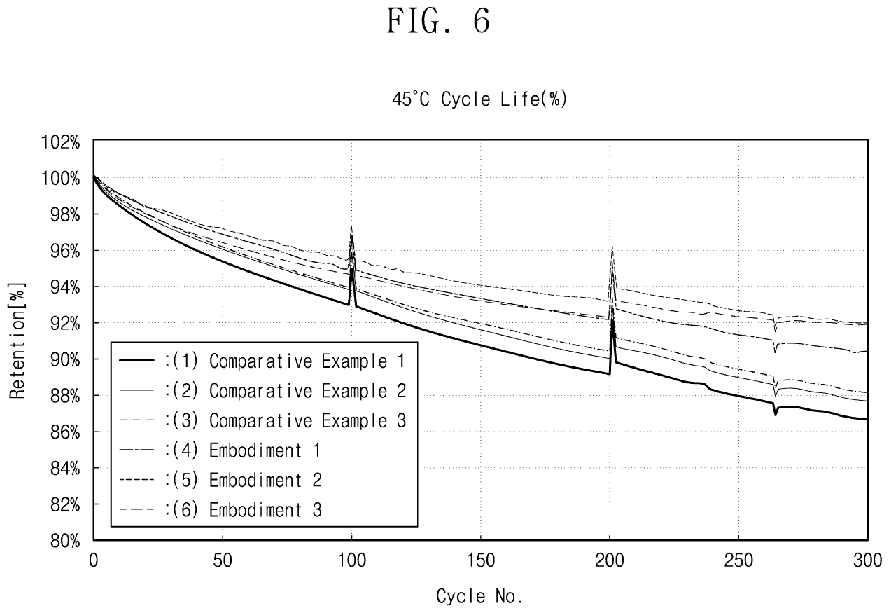

Rechargeable lithium batteries according to Embodiments 1 to 5 and Comparative Examples 1 to 6 were continuously charged and discharged at 45° C. for up to 300 cycles under the condition of 0.5 C charge and 0.5 C discharge, and a capacity retention rate after 300 cycles is listed in Table 2 below. FIG. 6 shows a graph showing capacity retention rates of some of the Comparative Examples and Embodiments.

A capacity retention rate was calculated according to Equation 2 below.

$$Capacity retention rate ( \% ) = ( discharge capacity at {300}^{th} cycle / initial discharge capacity ) \times 100 \qquad Equation 2$$

TABLE 2

| | First compound | | Second compound | | Capacity |
|---|---|---|---|---|---|
| | | Amount | | Amount | retention |
| | Kind | (wt %) | Kind | (wt %) | rate (%) |
| Embodiment | Chemical | 0.5 | Chemical | 1 | 90.34 |
| 1 | Formula 1A | | Formula 2D | | |
| Embodiment | Chemical | 1 | Chemical | 1 | 91.86 |
| 2 | Formula 1A | | Formula 2D | | |
| Embodiment | Chemical | 2 | Chemical | 1 | 91.87 |
| 3 | Formula 1A | | Formula 2D | | |
| Embodiment | Chemical | 3 | Chemical | 1 | 90.93 |
| 4 | Formula 1A | | Formula 2D | | |
| Embodiment | Chemical | 5 | Chemical | 1 | 90.41 |
| 5 | Formula 1A | | Formula 2D | | |
| Comparative | — | — | — | — | 86.60 |
| Example 1 | | | | | |
| Comparative | Chemical | 1 | — | — | 87.65 |
| Example 2 | Formula 1A | | | | |
| Comparative | — | — | Chemical | 1 | 88.13 |
| Example 3 | | | Formula 2D | | |
| Comparative | Chemical | 1 | Chemical | 1 | 88.09 |
| Example 4 | Formula 3 | | Formula 2D | | |
| Comparative | Chemical | 2 | Chemical | 1 | 87.90 |
| Example 5 | Formula 3 | | Formula 2D | | |
| Comparative | Chemical | 3 | Chemical | 1 | 88.54 |
| Example 6 | Formula 3 | | Formula 2D | | |

Referring to Table 2 and FIG. 6, it may be ascertained that the capacity retention rate after 300 cycles is higher in the rechargeable lithium batteries according to Embodiments 1 to 5 in which the compound represented by Chemical Formula 1A and the compound represented by Chemical Formula 2D were added as the additive than in the rechargeable lithium batteries according to Comparative Examples 1 to 6.

In a rechargeable lithium battery according to an embodiment, lifetime characteristics may be improved, and a battery resistance increase may be suppressed or reduced at high-temperature storage.

While the subject matter of this disclosure has been described in connection with what is presently considered to be example embodiments, it is to be understood that the present disclosure is not limited to the disclosed embodiments and is intended to cover various modifications and equivalent arrangements included within the spirit and scope of the appended claims and equivalents thereof, and therefore the aforementioned embodiments should be understood to be examples but not limiting this disclosure in any way.

What is claimed is:

1. An electrolyte for a rechargeable lithium battery, comprising:
a non-aqueous organic solvent;
a lithium salt; and
an additive,
wherein the additive comprises a first compound represented by Chemical Formula 1 and a second compound represented by Chemical Formula 2, 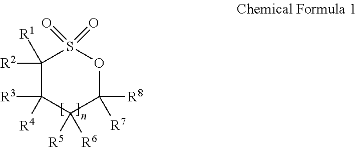
wherein, in Chemical Formula 1,
R¹ to R⁸ are each independently hydrogen or a substituted or unsubstituted C10 to C10 alkyl group, and
n is an integer of 1 to 8, and 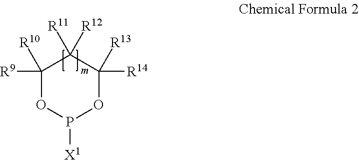
wherein, in Chemical Formula 2,
X¹ is a fluoro group, a chloro group, a bromo group, or an iodo group,
R⁹ to R¹⁴ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
m is 0 or 1.

2. The electrolyte as claimed in claim 1, wherein the first compound is present in an amount of about 0.5 parts by weight to about 5.0 parts by weight relative to 100 parts by weight of the electrolyte for the rechargeable lithium battery.

3. The electrolyte as claimed in claim 1, wherein the first compound is present in an amount of about 1.0 part by weight to about 3.0 parts by weight relative to 100 parts by weight of the electrolyte for the rechargeable lithium battery.

4. The electrolyte as claimed in claim 1, wherein the second compound is present in an amount of about 0.2 parts by weight to about 2.0 parts by weight relative to 100 parts by weight of the electrolyte for the rechargeable lithium battery.

5. The electrolyte as claimed in claim 1, wherein the second compound is present in an amount of about 0.5 parts by weight to about 1.5 parts by weight relative to 100 parts by weight of the electrolyte for the rechargeable lithium battery.

6. The electrolyte as claimed in claim 1, wherein the additive is present in an amount of about 0.7 parts by weight to about 7 parts of weight relative to 100 parts by weight of the electrolyte for the rechargeable lithium battery.

7. The electrolyte as claimed in claim 1, wherein a weight ratio of the first compound to the second compound in the additive is in a range of about 1 to about 5.

8. The electrolyte as claimed in claim 1, wherein each of R¹ to R⁸ in Chemical Formula 1 is hydrogen.

9. The electrolyte as claimed in claim 1, wherein the first compound is represented by Chemical Formula 1A,

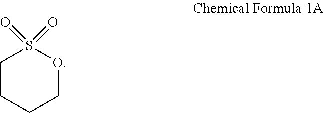

10. The electrolyte as claimed in claim 1, wherein the second compound is represented by Chemical Formula 2A or Chemical Formula 2B, 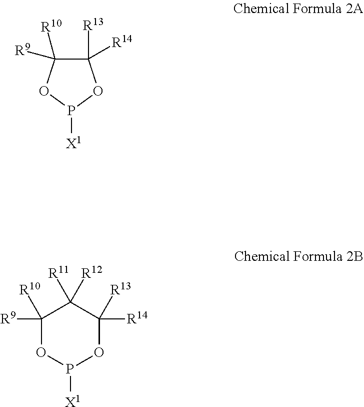
wherein, in Chemical Formula 2A and Chemical Formula 2B,
X¹ is a fluoro group, a chloro group, a bromo group, or an iodo group, and
R⁹ to R¹⁴ are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

11. The electrolyte as claimed in claim 10, wherein:
each of R⁹ and R¹⁰ in Chemical Formula 2A is hydrogen, and
at least one selected from R¹³ and R¹⁴ is a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

12. The electrolyte as claimed in claim 1, wherein the second compound comprises at least one selected from compounds represented by Chemical Formula 2C and Chemical Formula 2D,

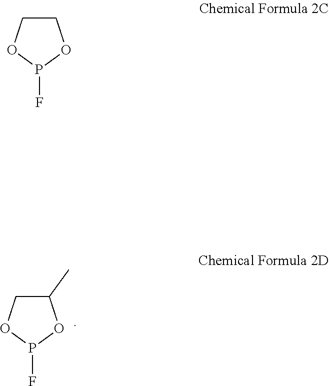

13. The electrolyte as claimed in claim 1, wherein the additive further comprises at least one selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithium tetrafluoroborate (LiBF₄), lithium difluorophosphate (LiPO₂F₂), and 2-fluoro biphenyl (2-FBP).

14. The electrolyte as claimed in claim 1, wherein the non-aqueous organic solvent comprises a carbonate-based solvent.

15. The electrolyte as claimed in claim 1, wherein the lithium salt comprises LiPF₆.

16. The electrolyte as claimed in claim 1, wherein a concentration of the lithium salt is in a range of about 0.1 M to about 2.0 M.

17. A rechargeable lithium battery, comprising:
a positive electrode that comprises a positive electrode active material;
a negative electrode that comprises a negative electrode active material; and
the electrolyte for the rechargeable lithium battery as claimed in claim 1.

18. The rechargeable lithium battery as claimed in claim 17, wherein the positive electrode active material comprises lithium-nickel-based oxide, lithium-cobalt-based oxide, lithium-manganese-based oxide, lithium-iron-phosphate-based compounds, cobalt-free nickel-manganese-based oxide, or any combination thereof.

19. The rechargeable lithium battery as claimed in claim 17, wherein the negative electrode active material comprises a carbon-based negative electrode active material, a Si-based negative electrode active material, or a combination thereof.
